(19) United States
(12) Patent Application Publication
(10) Pub. No.: US 2021/0302158 A1
(43) Pub. Date: Sep. 30, 2021

(54) PARALLEL PLATE CAPACITOR-BASED INCLINOMETER AND METHOD

(71) Applicant: KING ABDULLAH UNIVERSITY OF SCIENCE AND TECHNOLOGY, Thuwal (SA)

(72) Inventor: Sherjeel KHAN, Thuwal (SA)

(21) Appl. No.: 17/142,945

(22) Filed: Jan. 6, 2021

Related U.S. Application Data
(60) Provisional application No. 62/994,968, filed on Mar. 26, 2020.

(51) Int. Cl. G01C 9/06

(52) U.S. Cl. CPC G01C 9/06; G01C 2009/062

(57) ABSTRACT

A sensor for determining an angle of tilt includes a housing that defines a chamber, and a parallel plate capacitor having a moving plate located inside the chamber and a fixed plate fixedly attached to a first external side of the housing. The fixed plate has a width W that varies, and the moving plate is configured to freely rotate about an axis.

### CROSS-REFERENCE TO RELATED APPLICATIONS

This application claims priority to U.S. Provisional Patent Application No. 62/994,968, filed on Mar. 26, 2020, entitled “AN INCLINOMETER USING MOVABLE ELECTRODE IN A PARALLEL PLATE CAPACITIVE STRUCTURE,” the disclosure of which is incorporated herein by reference in its entirety.

### BACKGROUND

### Technical Field

Embodiments of the subject matter disclosed herein generally relate to a sensor for determining a tilt angle or angle of slope associated with an object, and more particularly, to an inclinometer that uses a capacitor having a fixed plate and a movable plate for measuring the tilt angle or angle of slope.

### Discussion of the Background

An inclinometer, often referred to as a tilt sensor, is used to measure the angle of inclination or the tilt angle of an object to which the inclinometer is attached to. Inclinometers generally determine the angle of inclination based on the angle between an axis of a freely hanging object and the gravitational force. These sensors are mostly used in areas such as automotive, robotics and construction. Typically, an inclinometer incorporates an accelerometer to measure the inclination angle in response to the direction of gravity (acceleration).

Over the past few decades, MEMS-based accelerometers have gained attention as they have high sensitivities and ranges. Some of the common transduction mechanisms in MEMS accelerometers are: capacitive, piezoresistive, resonant, thermal, and optical. Capacitive, piezoresistive and resonant accelerometers have a proof mass that accelerates in response to the gravitational force, and the displacement of the proof mass relative to the gravity is then related to the inclination angle.

The proof mass in the MEMS-based accelerometers has dimensions in the range of tens of micrometers, and thus, the proof mass is made using microfabrication processes, which increase the cost and complexity of the sensor. The raw output signal from the capacitive accelerometers has a low signal to noise ratio, which requires complex amplification and noise reduction circuits, which further adds to the complexity of the large scale manufacturing processes of such sensors and increases the power consumption of the sensor.

On the other hand, the piezoresistive sensors are sensitive to changes in temperatures and thus, they require temperature compensation techniques that further increase the complexity of the sensor. Although thermal accelerometers are much easier to fabricate as they do not have a proof mass, because their working principle is based on heat transfer and fluid flow, these accelerometers have a very slow response, which is undesired.

Additionally, the existing MEMS-based accelerometers have redundant features that are not needed in many applications where only the inclination angle needs to be found. The gravitational forces are comparatively small to other everyday forces. Movements that take place under the action of gravity do not require large bandwidth and ranges of acceleration that the MEMS accelerometers provide.

Specialized inclinometers use a free mass that is actuated due to the influence of the gravitational forces. Then, a particular mechanism measures the subsequent changes of the free mass. Fluidic tilt sensors measure the change in the resistance or capacitance of a fluid due to the movement of the fluid induced by the gravitational force. However, the presence of the fluid as the sensing element increases the manufacturing complexity of the device and the fluidic properties are affected by the changes in the environmental conditions.

The simplest and most effective form of inclinometers are pendulum based, but so far only fluid based inclinators have been made that use the pendulum effect [1-4]. Currently, there is no sensor or method available to electronically measure the inclination angle of a pendulum to provide information about the tilt angle of an object. Most pendulum based inclinometers are manually read using the naked eye. These types of inclinometers are very unreliable.

Thus, there is a need of specialized inclinometers that are designed to particularly measure inclination angles with higher performance and lower power consumption compared to the existing MEMS accelerometers, and also to have a low manufacturing cost, but at the same time, to be more accurate than the existing inclinometers.

### BRIEF SUMMARY OF THE INVENTION

According to an embodiment, there is a sensor for determining an angle of tilt. The sensor includes a housing that defines a chamber, and a parallel plate capacitor having a moving plate located inside the chamber and a fixed plate fixedly attached to a first external side of the housing. The fixed plate has a width W that varies, and the moving plate is configured to freely rotate about an axis.

According to another embodiment, a sensor assembly for determining a tilt angle, the sensor assembly includes a housing that defines a chamber, a parallel plate capacitor having a moving plate located inside the chamber, wherein the moving plate is configured to freely rotate inside the chamber, an electronic interface attached to an outside of the housing, a processor and a memory attached to the electronic interface and configured to calculate the tilt angle between a longitudinal axis of the moving plate and an axis of the housing, a communication device configured to transmit the tilt angle to an external device in a wireless manner, and a power source attached to the electronic interface and configured to power the processor, the memory and the communication device.

According to yet another embodiment, there is a method for assembling a sensor system for measuring a tilt angle. The method includes placing a first electrical terminal on a first side of an opened box so that the first electrical terminal extends inside of a chamber defined by the opened box, hanging a moving plate from an end of the first electrical terminal inside the chamber so that the moving plate rotates freely about the end of the first electrical terminal, closing the open box with a lid so that the chamber is fully closed, placing a fixed plate on an external surface of the lid, so that the moving plate and the fixed plate form a parallel plate capacitor, and the moving plate is inside the chamber and the fixed plate is outside the chamber, attaching a processor and a memory to the lid or the open box, attaching a communication device to the lid or the open box, the communication device being configured to transmit the tilt angle to an external device in a wireless manner, and providing a power source to power the processor, the memory and the communication device.

### BRIEF DESCRIPTION OF THE DRAWINGS

For a more complete understanding of the present invention, reference is now made to the following descriptions taken in conjunction with the accompanying drawings, in which:

FIG. 1 is an overview of a parallel plate capacitor based inclinometer having a moving plate;

FIG. 2 is a transversal cross-section of the parallel plate capacitor based inclinometer;

FIG. 3 shows a shape of a fixed plate of the parallel plate capacitor based inclinometer;

FIG. 4 shows another transversal cross-section of the parallel plate capacitor based inclinometer with the housing fully closed;

FIGS. 5A to 5C illustrate how the overlapping area between the moving plate and the fixed plate of the parallel plate capacitor changes as the sensor is tilted clockwise or counterclockwise;

FIG. 6 illustrates the parallel plate capacitor based inclinometer being attached to an object and having electronic components for calculating the tilt angle and broadcasting it to an external device;

FIG. 7 is a graph showing the change in the overlapping area of the plates of the parallel plate capacitor with a tilt angle of the inclinometer;

FIG. 8 is a graph that compares the change in the overlapping area and the change in the capacitance of the parallel plate capacitor with the tilt angle of the inclinometer;

FIG. 9 is a graph that compares the change in the estimated capacitance and the measured capacitance of the parallel plate capacitor with the tilt angle of the inclinometer;

FIG. 10 is a graph that plots the change in the capacitance of the parallel plate capacitor over time as the inclinometer is tilted with various angles;

FIG. 11 is a table illustrating various parameters of existing tilt sensor in comparison to the parallel plate capacitor based inclinometer discussed herein;

FIG. 12 illustrates the capacitance of the parallel plate capacitor based inclinometer when tilted with positive and negative tilt angles;

FIG. 13 illustrates the capacitance of the parallel plate capacitor based inclinometer when at room temperature and also heated to 100° C., and

FIG. 14 is a flow chart of a method for assembling a parallel plate capacitor based inclinometer.

### DETAILED DESCRIPTION OF THE INVENTION

The following description of the embodiments refers to the accompanying drawings. The same reference numbers in different drawings identify the same or similar elements. The following detailed description does not limit the invention. Instead, the scope of the invention is defined by the appended claims. The following embodiments are discussed, for simplicity, with regard to a tilt sensor that can be home made, with only materials available around the house. However, the embodiments to be discussed next are not limited to a homemade device, but may be applied to industrially manufactured sensors that use the same principles as the home made sensor.

Reference throughout the specification to “one embodiment” or “an embodiment” means that a particular feature, structure or characteristic described in connection with an embodiment is included in at least one embodiment of the subject matter disclosed. Thus, the appearance of the phrases “in one embodiment” or “in an embodiment” in various places throughout the specification is not necessarily referring to the same embodiment. Further, the particular features, structures or characteristics may be combined in any suitable manner in one or more embodiments.

According to an embodiment, an inclinometer or tilt sensor is made to have a movable plate acting as a pendulum inside a parallel plate capacitor. The movable plate acts as the bottom plate of the capacitor while the top plate is a fixed metal with a varying area, for example, in the shape of a triangle. When the bottom plate moves under the influence of the gravity relative to the fixed plate, the overlapping area of the two plates of the parallel plate capacitor varies, which corresponds to a change in the capacitance of the parallel plate capacitor. The relation between the angle of tilt, the overlapping area of the two plates, and the output capacitance of the capacitor is derived and used to covert the output capacitance to the tilt angle. In one application, the inclinometer has a range of 50° with a resolution of 0.38° and a response time of about 130 ms.

This configuration has a pronounced advantage over current inclinometers as the current inclinometers incorporate MEMS-based accelerometers, which as discussed above, need complex interface circuitry and are expensive to produce while having redundant features that are not required for many inclinometer applications. Other specialized inclinometers use fluids that are prone to environmental changes and complex to manufacture due to the presence of fluids, and all of these disadvantages are overcome by the present tilt sensor.

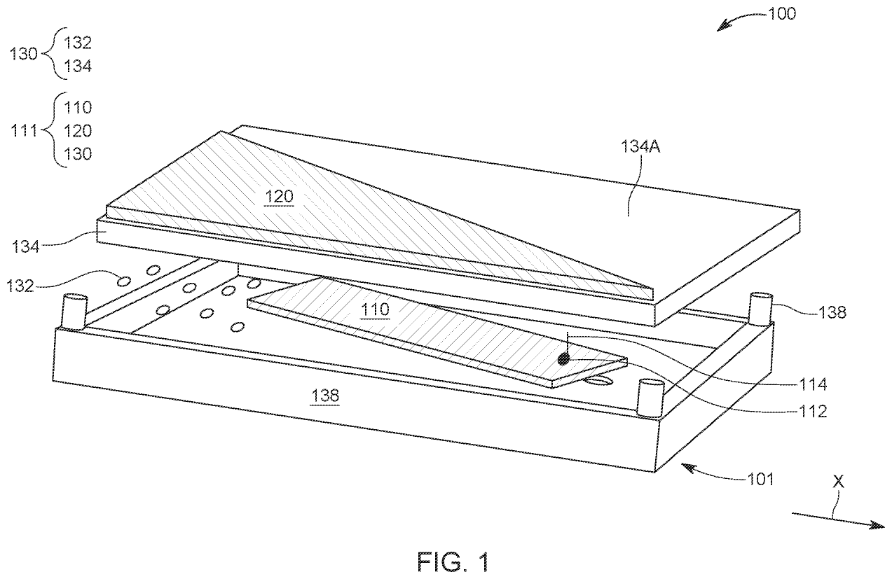

In one embodiment, as illustrated in FIG. 1, a tilt sensor or inclinometer 100 is configured to find an inclination angle by using a pendulum like freely moving metal plate 110, which is part of a parallel plate capacitive structure 111. The parallel plate capacitive structure or capacitor 111 includes two metal plates, the moving metal plate 110 and an additional fixed metal plate 120, which are separated by a dielectric material 130. In the embodiment shown in the figure, the dielectric material 130 includes a layer of air 132 and also a layer of a polymer 134, which in fact forms the lid of a housing 101.

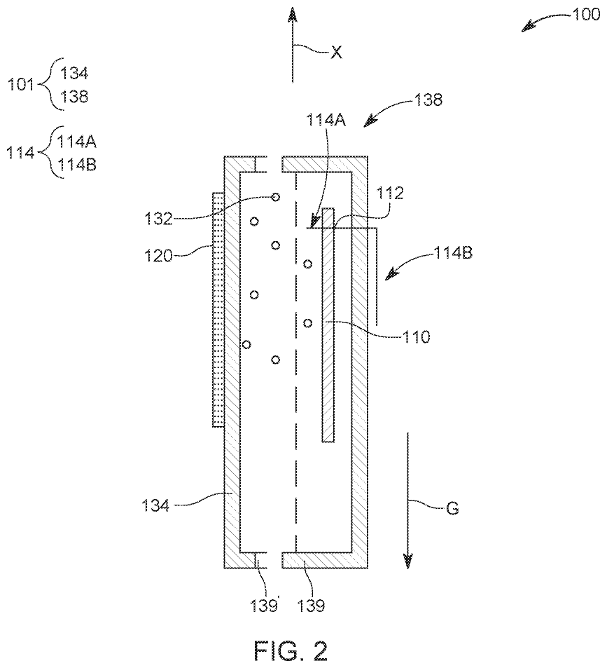

The housing 101 has a base or open box 138 that is configured to house the first moving plate 110. The dielectric material 134 is shaped to fit the box 136 as a lid. Thus, the lid 134 may be detachably attached to the box 138, for example, using one or more posts 139. The posts are fixedly attached either to the box or to the lid, and corresponding holes 139′ (see FIG. 2) are formed in the lid or box, respectively. Thus, when the lid is placed over the box, the posts enter inside the corresponding holes and ensure that the lid does not fall off the box. In one embodiment, it is possible that a glue or other similar material is placed on the posts or holes or box to ensure a good adherence between the lid and the box. The box and the lid may be made of the same material or different materials. They may be made of any materials as long as the materials are dielectric materials.

As shown in FIG. 1, a part of the capacitor 111 is located inside the housing 101 and the other part is located outside the housing. Part of the housing forms the dielectric material of the capacitor. In this configuration, the moving plate 110 is attached at one location 112 to the box 138, so that it can act as a pendulum when the box is placed in a vertical position. A conducting material shaped as a pin 114 may be attached to the box 138, to hold the moving plate 110 attached at the given location 112, as shown in FIG. 2. FIG. 2 shows the pin 114 having a first portion 114A that enters inside the box 138, and a second portion 114B that extends along an outside side of the box. The moving plate 110 is seen in a vertical position in FIG. 2, facing the fixed plate 120, and extending along the X direction. The X direction coincides in this embodiment with a longitudinal axis of the moving plate 110 and also is opposite to the gravity axis G. The fixed plate 120 is fixedly attached to the lid 134.

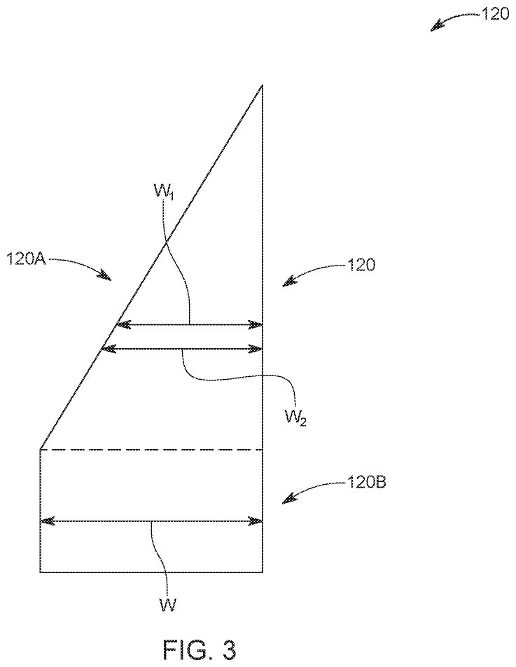

Returning to FIG. 1, the fixed plate 120 is made to have a varying width along the longitudinal axis X of the moving plate 110, i.e., for at least a portion of the fixed plate 120, for each location of the at least a portion of the fixed plate 120 along the X axis, a corresponding width is different from a width of an adjacent location of the at least a portion of the fixed plate. For the embodiment illustrated in FIG. 1, the at least a portion extends over the entire fixed plate. However, as shown in FIG. 3, the fixed plate 120 may have the at least a portion 120A of the plate 120 having the width W varying from one location (W1) to an additional location (W2), while another portion 120B has a constant width W. Thus, any shape can be used for the fixed plate 120 as long as there is the at least one portion 120A with the varying width W. Returning to FIG. 1, a portion 134A of the lid 134 is not covered by the fixed plate 120. In one embodiment, the portion 134A can have an area as large as half the surface area of the lid 134. In one embodiment, the area of the fixed plate 120 is half or less than the area of the portion 134A.

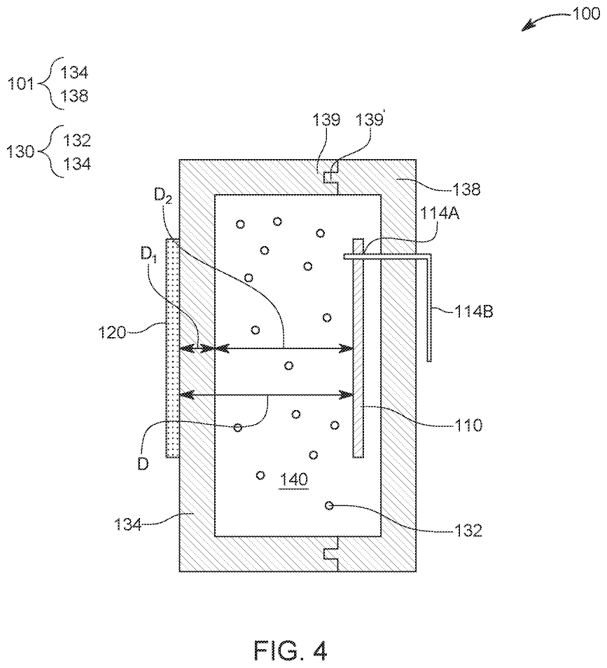

As shown in FIG. 4, when the lid 134 is placed in contact with the box 138, a closed chamber 140 is formed within the housing 101, which ensures that a distance D between the fixed plate 120 and the moving plate 110 does not change. In addition, the chamber 140 ensures that most of the ambient factors cannot alter the objects inside the chamber, for example, to change the dielectric constant of the medium between the two plates 110 and 120. With the configuration shown in FIG. 4, the dielectric material 130 between the two plates 110 and 120 has a multi-layer structure, and includes the material of the lid 134 and the air layer 132 found inside the chamber 140. The distance D between the two plates 110 and 120 is given by (1) D1, which is the thickness of the lid 134, and (2) D2, which is the thickness of the air layer 132. Note that although the fixed plate 120 may be attached to the outside side of the lid 134 with a glue or bolt or screw or other equivalent material, it is considered that this extra material does not affect the dielectric constant of the material between the two plates.

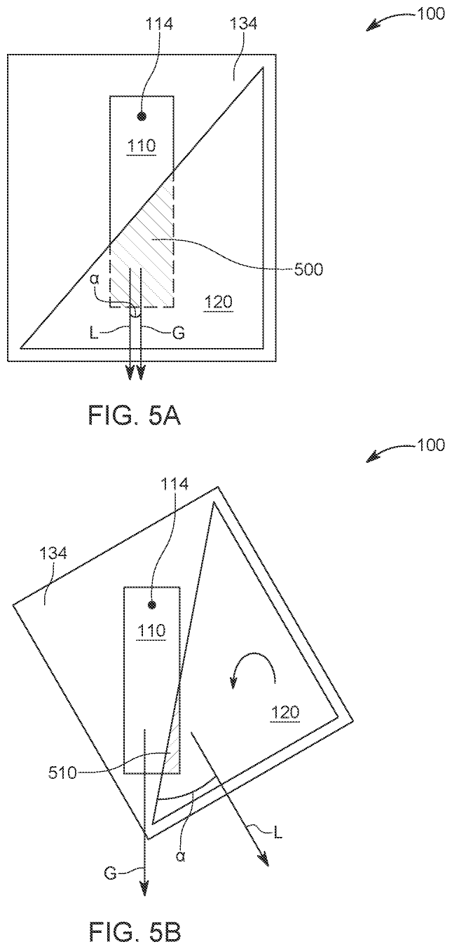

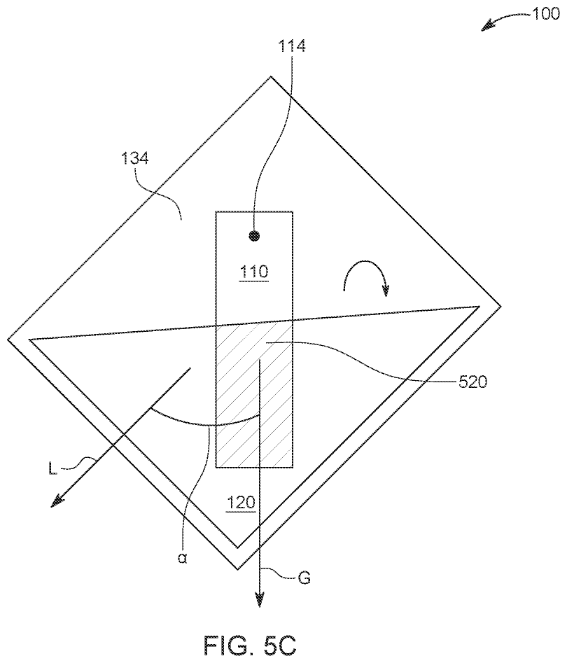

The effective capacitance of the parallel plate capacitor 111 depends upon the overlapping area of the two metal plates 110 and 120. For the configuration shown in FIG. 1, the two metal plates are partially overlapped as indicated by area 500 in FIG. 5A, because of the varying shape of the fixed plate 120. Note that a longitudinal axis L of the sensor 100 is aligned in this embodiment to the gravity direction G, i.e., the angle α between the two axes is zero. The configuration of the parallel plate capacitive structure 111 acts such that when the capacitor is tilted in an anticlock-wise direction, as shown in FIG. 5B, the bottom plate 110 maintains its orientation along the gravity direction G, while all the other parts of the sensor rotate, so that the longitudinal axis L of the sensor 100 makes a non-zero angle α with the gravity G. Due to the change of the effective overlapping area 510 (this area decreases relative to the original area 500 shown in FIG. 5A) of the top and bottom plates 110 and 120, the capacitance of the structure 111 changes accordingly. If the sensor 100 is rotated in the opposite direction, as illustrated in FIG. 5C, the tilt angle α is again formed between the gravity direction G and the longitudinal axis L of the sensor and the overlapping area 520 has increased relative to the reference area 500 in FIG. 5A. This means, that the overlapping area can be used to estimate the tilt angle α.

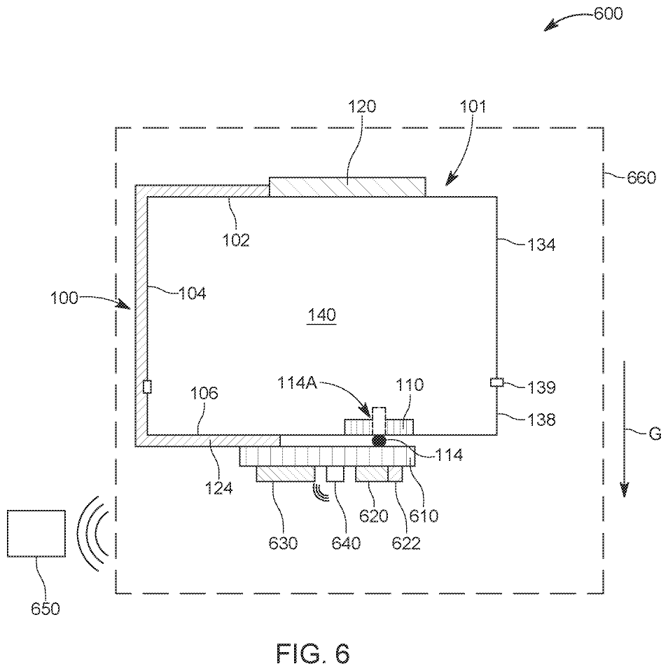

The two plates 110 and 120 are each connected to a corresponding electrical terminal 114, and 124, respectively, as shown in FIG. 6. FIG. 6 is a cross-section of the sensor 100, and shows a housing 101 of the sensor being made of the box 138 and the lid 134. The fixed plate terminal 124 extends from the fixed plate 120, along a first side 102 of the housing 101, an entire second side 104 of the housing, and partially along a third side 106 of the housing, where the third side 106 is opposite to the first side 102. In one embodiment, the fixed plate terminal 124 and the fixed electrode 120 may be made of the same material, e.g., a copper tape. In one embodiment, the fixed plate terminal and the fixed plate are made as an integral single piece. The fixed plate terminal 124 ends on the same third face 106 as the terminal 114, which makes easier to electrically connect the entire sensor to an electrical circuit for reading the tilt angle between the longitudinal axis of the moving plate and the gravity.

For example, as also illustrated in FIG. 6, the two electrical terminals 114 and 124 may be electrically connected to an electronic interface or substrate 610, to which a processor 620 and a power source 630 are also attached. The processor 620 may have a memory device 622 for storing the collected information, and, for example, an algorithm for transforming the collected capacitance into the associated tilt angle. A communication device 640 (for example, Bluetooth enable transceiver) may also be attached to the substrate 610 and powered by the power source 630. Such a sensor package 600 is then able not only to determine the tilt angle of the housing 101 relative to the gravity direction G, but also to send the angle to an external device, e.g., server or computer or mobile device 650, in a wireless manner, to alert the external device about a change in the angle. The fixed plate terminal 124, by extending from the first side to the third side of the housing, can in effect make the lid to stay attached to the box so that the housing 101 remains closed during usage.

In one embodiment, the housing 101 of the sensor assembly 600 can be fixedly attached to an object 660, for example, a laptop or an object of art, for determining when the object is moved (i.e., is tilted) from its rest position. The processor 620 may be configured to measure the tilt angle and compare with a threshold value, and if the measured angle is larger than the threshold value, to send a warning signal to the external device 650. In this way, the external device 650 becomes aware that somebody or something is interfering with the object 660, and can take action to verify that the object is not removed from its location. Thus, the sensor system 600 can be used for theft deference, object monitoring, and/or object protection.

The substrate 610 may also include a capacitance to digital converter, which in one application, can be implemented in the processor 620. A mathematical relation is derived by the processor 620, based on the software instructions stored in the memory 622, to convert the value of the capacitance of the parallel plate capacitor 111 into the angle of inclination of the housing 101 relative to the gravity axis. Thus, it is possible to directly relate the change in the capacitance of the sensor 100 to the angle of tilt. In this regard, FIGS. 5B and 5C show that the overlapping area 500 of the two plates 110 and 120 is directly related to the tilt angle α because when the inclinometer is tilted anti-clockwise (see FIG. 5B), the overlapping area is seen to decrease and when the inclinometer is tilted clockwise (see FIG. 5C), the overlapping area increases.

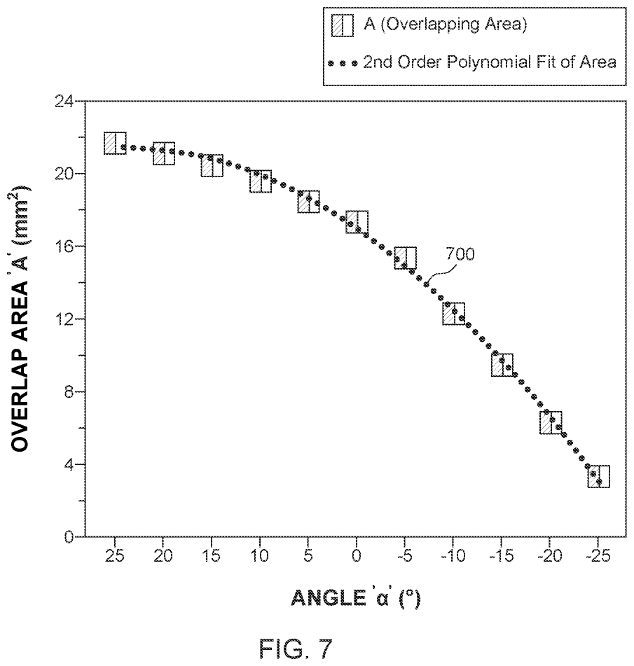

As known from the equation of a parallel plate capacitor, see equation (1), the overlapping area ‘A’ is directly proportional to the capacitance ‘C’,

$$C = ɛ \frac{A}{D} , \qquad ( 1 )$$

where ‘ε’ is the permittivity of the dielectric layer 130, and ‘D’ is the thickness of the dielectric layer 130. Thus, this equation can be used to relate the tilt angle α to the capacitance C to determine the output of the inclinometer, as now discussed. First, the mathematical relation between α and C is found by plotting the overlap area A for various angles of tilt (α), as shown in FIG. 7. In the figure, the overlapping area A of the two parallel plate capacitor 111 varies according to the angle α, where the overlapping area A was geometrically calculated for angles between −25° to +25° for every 5° intervals. For each angle, the overlapping area A is either in the form of a triangle 510 (from −25° to −10°), as shown in FIG. 5B, or a trapezoid 520 (from −10° to 25°) as seen in FIG. 5C.

The relationship between A and a is found to be described by a second order polynomial given by Equation (2):

A=0.367α−0.008α²+17. (2)

It can be seen that the curve 700 in FIG. 7 can be approximated as two linear regimes, from −25° to 0° and from 0° to 25°. By replacing the value of A from equation (1) with its expression given by equation (2), it is possible to find the relation between the output capacitance C of the tilt sensor 100 and the angle of tilt a, as given by equation (3):

$$c = \frac{ɛ ( 0.367 α - 0.008 {α}^{2} + 17 )}{d} . \qquad ( 3 )$$

This relationship is then used by the processor 620 to find the capacitance of the parallel plate structure 111 in terms of the tilt angle for the inclinometer 100.

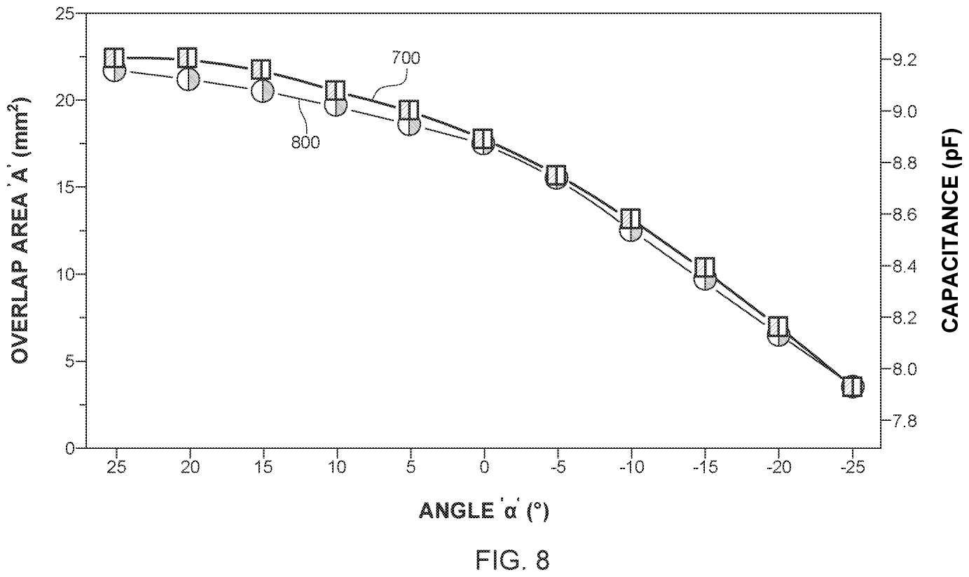

To verify the relationship between the tilt angle α, the overlapping area A and the output capacitance C, the inventors ran FEM simulations of a model of the inclinometer 100. At a tilt angle of −25°, the overlapping area is least and thus, a small electric field is present, which means a smaller capacitance. As the moving plate rotates towards an angle of +25°, an increase in the electric field is found between the plates of the capacitor, which results in an increased capacitance. The value of the capacitance at each angle is plotted in FIG. 8. In the same figure, when the mathematical calculated overlapping area from FIG. 7 is also plotted, it can be seen that the working principle of the sensor 100 is further validated as the overlapping area curve 800 of the inclinometer is indeed directly proportional to the output capacitance curve 700. As the overlapping area changes due to the titling of the sensor 100, the output capacitance changes accordingly. The inclinometer shows a repeatable response between −25° to +25° with a linear response between −25° to +15°. This resolution allows detection of small movements of less than one-degree tilt.

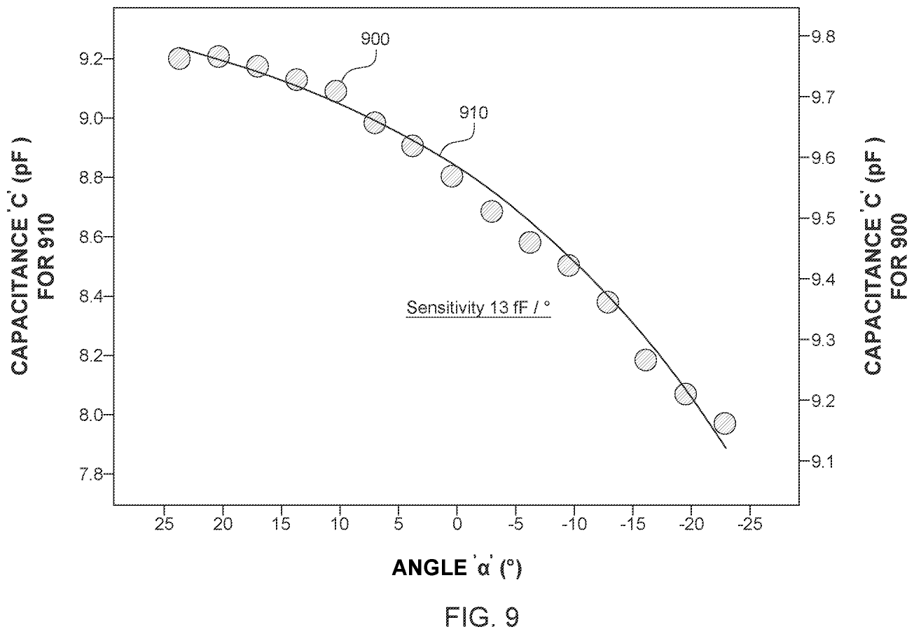

The response of the inclinometer output capacitance is plotted against the tilt angle in FIG. 9. It can be seen that the experimental response 900 coincides with the simulated response 910 that was found in the FEM simulation discussed above. The sensitivity of 13 fF/° resulted in a resolution of 0.38°. Because the movable plate in the inclinometer moves under the influence of gravity to detect movement, an extremely fast response time of about 130 ms was measured.

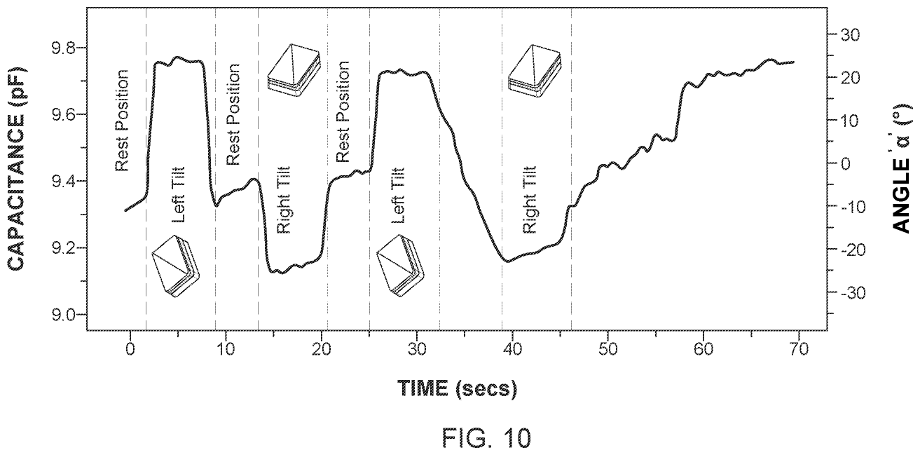

FIG. 10 shows the response of the inclinometer from a test in which the inclinometer is tilted at different orientations and speeds. The sensor is started at rest position and sequentially titled left to right at various levels of inclination angles. With the width of the box 138 in the range of 1 cm or less, the sensor 100 can record angles from −25° to 25°. The sensor was then moved slowly from −25° to 25° to show its linear response, also illustrated in FIG. 10.

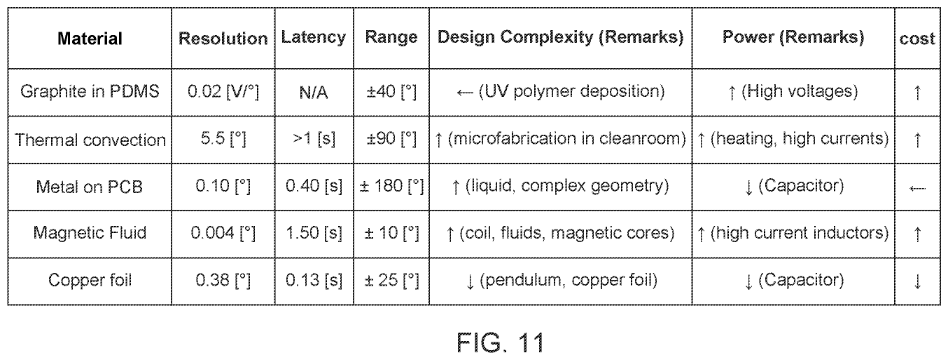

One advantage of the inclinometer 100's configuration is the simplicity of the design, the reduced power consumption, and the low overall cost of fabrication. The table in FIG. 11 shows a summary of different designs that have been used to form traditional inclinometers, and their properties are compared with the design of the sensor 100 (illustrated in the last row of the table). Most of the existing designs and the accelerometer based commercial inclinometers have a higher resolution, but at the cost of the increased design complexity and power consumption. With the increased design complexity and power consumption, the overall cost of the device goes high.

Such inclinometers that are expensive and very accurate do find applications in several areas. However, in certain applications, a high-level of accuracy is often not necessarily desired. Instead, lower cost and reduced power consumption is preferred. For example, collision detection devices in cars do not require high accuracy as the acceleration produced in an accident is very large, and the device only needs to know if the acceleration produced by the collision is above a certain threshold. Alternatively, a security tag installed on a painting in a museum needs to detect if sufficient movement has occurred, which can correspond to a possible attempt of theft. In these scenarios, accuracies below 0.1° become redundant. In such applications, a faster response time is preferred.

Each of the designs outlined in the table in FIG. 11 incorporates objects submerged in liquids or they rely on the movement of the liquids due to thermal convection, which significantly reduces the response time, as liquids are more viscous than the air. Contrary to these sensors, the sensor 100 discussed above has a pendulum (moving plate) that hangs in the air enclosed in the chamber formed by the housing of the sensor, thus avoiding the drawbacks associated with the presence of the liquids.

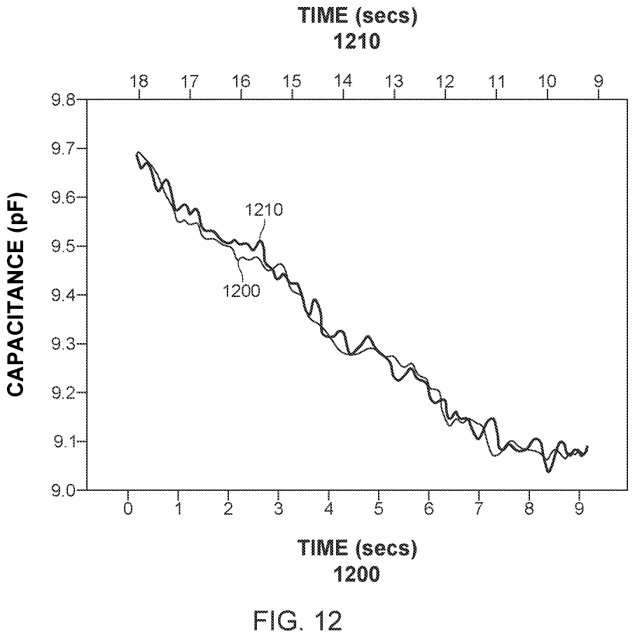

Additionally, the sensor 100 does not exhibit hysteresis for the reason that the air has a significantly lower damping factor than the liquids. The free moving plate 110 moves in the air trapped inside the housing 101, under the influence of the constant gravitational force. As soon as the inclinometer is tilted, the pendulum moving plate 110 remains to the same position every time with respect to the input inclination angle while the housing and the fixed plate 120 rotate. Consequently, the output capacitance also remains equal for each inclination angle. To verify this observation, the inventors have conducted an experiment in which the inclinometer 100 was attached to a continuous rotation servo motor. In this way, it was possible to precisely control the speed of rotation of the inclinometer using the continuous rotation servomotor in order to observe the output response of the inclinometer when it moves from one end to another and then back to the starting position. In this regard, FIG. 12 shows the output capacitance plotted against the time as curve 1200 when the inclinometer is moved from +25° to −25°, and as curve 1210 when the inclinometer is moved from −25° to +25°. It can be seen that both curves 1200 and 1210 have similar values at each time instant corresponding to the respective inclination angle.

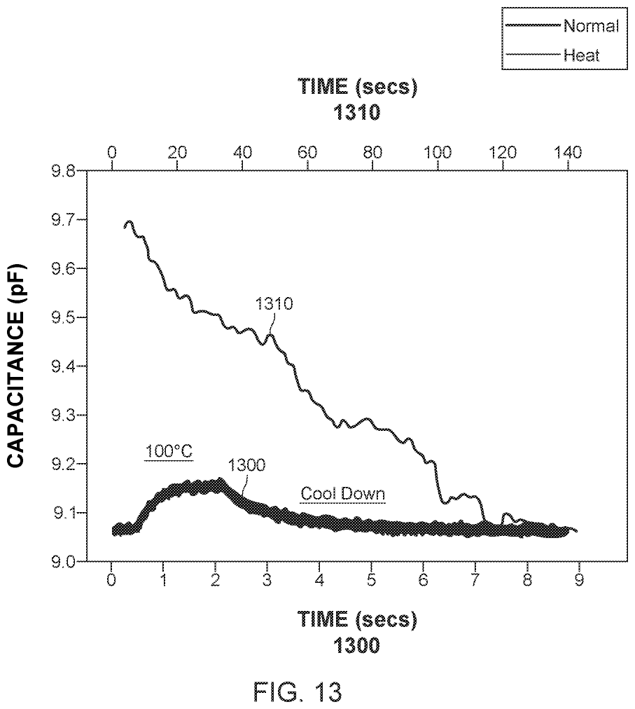

Because metal plates are used for both the fixed plate 120 and the moving plate 110, the ambient heat may cause an increase in the capacitance as the resistance of the fixed plate (e.g., copper foil) increases. In order to measure the extent of the effect of the ambient heat on the performance of the inclinometer, the inventors have heated the sensor using a 100° C. heat source for 30 seconds and then let it cool down for 110 seconds. The change in the capacitance due to the applied heat is plotted as curve 1300 in FIG. 13 along with the normal response curve 1310 of the inclinometer 100 when moved from +25° to −25°. It can be seen that the capacitance of the inclinometer changes from 9.08 pF to 9.14 pF for a temperature change of 25° C. to 100° C. On the other hand, the net change in the capacitance of the inclinometer when moved from +25° to 25° is 0.62 pF. Thus even for extreme temperature changes of 75° C., only a small increase is observed in the output capacitance (0.06 pF), which is 9% of the maximum possible capacitance change (0.62 pF). The total change per degree centigrade comes down to a mere 0.0008 pF/° C. Thus, for small to moderate changes in temperature, the ambient heat does not significantly alter the tilt angle readings. Furthermore, once left to cool down after heating, the output of the inclinometer 100 returns to its original position as the curves 1300 and 1310 coincide after about 7 s.

Thus, the embodiments discussed herein have shown a freely moving mass based inclinometer sensor which can provide digital information about the tilt angle to as low as 0.38° using a parallel plate capacitive structure. The mathematical result area were validated using FEM simulations and experiments. The parallel plate capacitor has, in one embodiment, only two output terminals that can be connected directly to an electronic interface to provide accurate information about the angle of inclination. The simplicity of the design and electronic interface allows it to be used as an add-on to enhance the functionality of existing devices, for example, as an anti-theft device.

When the inclinometer is attached to a Bluetooth wireless interface or similar communication platform, as discussed with regard to FIG. 6, it can be attached to valuable items such as a painting or a laptop as an add-on to provide notification if the item is displaced from its resting position. The add-on approach has shown its advantages in the past by adding functionality to plants and marine species. One advantage of using a capacitive structure to measure the tilt angle is that it does not require an active source of power. A capacitance to digital convertor only power ups the sensor when it needs to extract data, which can vary depending upon the desired logging interval. Thus, the sensor assembly 600 discussed herein consumes much less power in comparison to the existing resonant and piezoresistive sensors, which require an active activation source in order to function.

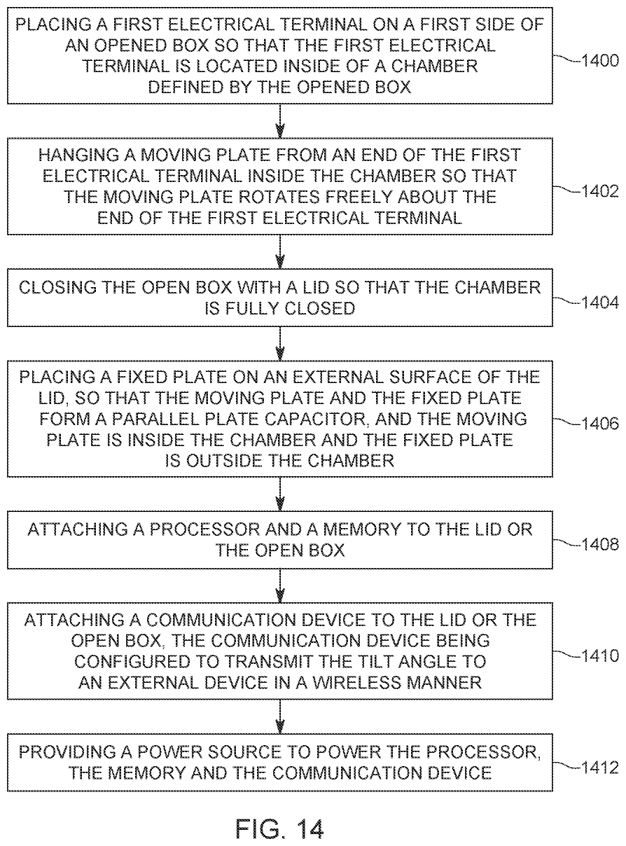

A method for assembling a tilt sensor as discussed above is now discussed with regard to FIG. 14. The assembly process starts in step 1400 with a customized 3D printed housing 101 (note that other processes may be used for manufacturing the open box 138 and the lid 134) having a hole in the middle of the bottom plate through which a (rigid) metal wire 114 is passed through. This first electrical terminal acts as a frictionless pivot point which carries the moving plate 110 like a pendulum such that the moving plate can swing under the force of acceleration (movement) or gravity (tilt). Then, the moving plate 110 is added in step 1402 to the first electrical terminal 114. Subsequently, the lid 134 is placed in step 1404 over the open box 138 to close the box and form the housing 101, which secures the moving plate 110. In one embodiment, the height of the housing 101 is about 2 mm and the thickness of the moving plate 110 is 1 mm, so that the moving plate can move freely in the chamber 140 defined inside the housing 101.

In step 1406, the fixed plate 120 is attached to the lid. In one application, the fixed plate 120 is a copper tape shaped like a triangle is attached to the top of the lid. The fixed plate can be wrapped in this embodiment towards the back side of the box so that it also acts as a second electrical terminal 124 and both terminals 114 and 124 are in the same place for easier integration with the electronic interface 610. The shape of the fixed plate is made in the shape of a triangle such that it has variable area across the width of the sensory platform.

Then, in step 1408, a processor and a memory may be attached to the lid or the box. The processor and the memory serve to receive a signal from the parallel plate capacitor 111, to determine a change in its capacitance when the capacitor is tilted or rotated about the first electrical terminal 114. The processor is further configured to map the calculated capacitance to a corresponding tilt angle, as the sensor has been previously calibrated to establish the correspondence between the capacitance and the tilt angle. A communication device 640 is attached to the housing 101 in step 1410 for communicating the calculated tilt angle when a value of such angle is larger than a given threshold. For powering all these electronic components, a power source 630 is added to the housing 101 in step 1412.

The disclosed embodiments provide a tilt sensor that is inexpensive to manufacture and uses low power. It should be understood that this description is not intended to limit the invention. On the contrary, the embodiments are intended to cover alternatives, modifications and equivalents, which are included in the spirit and scope of the invention as defined by the appended claims. Further, in the detailed description of the embodiments, numerous specific details are set forth in order to provide a comprehensive understanding of the claimed invention. However, one skilled in the art would understand that various embodiments may be practiced without such specific details.

Although the features and elements of the present embodiments are described in the embodiments in particular combinations, each feature or element can be used alone without the other features and elements of the embodiments or in various combinations with or without other features and elements disclosed herein.

This written description uses examples of the subject matter disclosed to enable any person skilled in the art to practice the same, including making and using any devices or systems and performing any incorporated methods. The patentable scope of the subject matter is defined by the claims, and may include other examples that occur to those skilled in the art. Such other examples are intended to be within the scope of the claims.

### REFERENCES

[1] U.S. Pat. No. 2,033,127.
[2] U.S. Pat. No. 2,154,678.
[3] U.S. Pat. No. 4,667,413.
[4] G. Mellin, P. Olenius and H. Setala, Physiotherapy 80 (9), 612-614 (1994).

What is claimed is:

1. A sensor for determining an angle of tilt, the sensor comprising:
a housing that defines a chamber; and
a parallel plate capacitor having a moving plate located inside the chamber and a fixed plate fixedly attached to a first external side of the housing,
wherein the fixed plate has a width W that varies, and
wherein the moving plate is configured to freely rotate about an axis.

2. The sensor of claim 1, wherein an overlapping area of the moving plate and the fixed plate changes as the housing is tilted.

3. The sensor of claim 1, wherein an overlapping area of the moving plate and the fixed plate for a first orientation of the housing is different from another overlapping area of the moving plate and the fixed plate for a second orientation of the housing, and the second orientation is different from the first orientation.

4. The sensor of claim 1, wherein a shape of the fixed plate is triangular.

5. The sensor of claim 1, wherein the housing is fully closed.

6. The sensor of claim 1, wherein the housing is made of a dielectric material.

7. The sensor of claim 1, further comprising:
a first electrical terminal that partially enters into the chamber and extends through the moving plate so that the moving plate freely rotates about the first electrical terminal.

8. The sensor of claim 7, wherein a part of the first electrical terminal extends along a second external side of the housing, wherein the second external side is opposite to the first external side.

9. The sensor of claim 7, wherein the fixed plate extends from the first external side to the second external side, to form a second electrical terminal.

10. The sensor of claim 9, wherein the fixed plate is a copper tape that adheres to the housing.

11. The sensor of claim 1, further comprising:
an electronic interface attached to an outside of the housing;
a power source attached to the electronic interface;
a processor and a memory attached to the electronic interface and configured to measure a tilt angle between a longitudinal axis of the moving plate and an axis of the housing; and
a communication device that is configured to transmit the tilt angle to an external device.

12. A sensor assembly for determining a tilt angle, the sensor assembly comprising:
a housing that defines a chamber;
a parallel plate capacitor having a moving plate located inside the chamber, wherein the moving plate is configured to freely rotate inside the chamber;
an electronic interface attached to an outside of the housing;
a processor and a memory attached to the electronic interface and configured to calculate the tilt angle between a longitudinal axis of the moving plate and an axis of the housing;
a communication device configured to transmit the tilt angle to an external device in a wireless manner; and
a power source attached to the electronic interface and configured to power the processor, the memory and the communication device.

13. The sensor assembly of claim 12, wherein the parallel plate capacitor further comprises a fixed plate fixedly attached to a first external side of the housing, and
wherein the fixed plate has a width W that varies.

14. The sensor assembly of claim 13, wherein an overlapping area of the moving plate and the fixed plate changes as the housing is tilted.

15. The sensor assembly of claim 13, wherein an overlapping area of the moving plate and the fixed plate for a first orientation of the housing is different from another overlapping are of the moving plate and the fixed plate for a second orientation of the housing, and the second orientation is different from the first orientation.

16. The sensor assembly of claim 13, wherein a shape of the fixed plate is triangular, the housing is fully closed, and the housing is made of a dielectric material.

17. The sensor assembly of claim 12, further comprising:
a first electrical terminal that partially enters into the chamber and extends through the moving plate so that the moving plate freely rotates about the first electrical terminal.

18. The sensor assembly of claim 17, wherein a part of the first electrical terminal extends along a second external side of the housing, wherein the second external side is opposite to the first external side.

19. The sensor assembly of claim 17, wherein a fixed plate extends from the first external side to the second external side, to form a second electrical terminal.

20. A method for assembling a sensor system for measuring a tilt angle, the method comprising:
placing a first electrical terminal on a first side of an opened box so that the first electrical terminal extends inside of a chamber defined by the opened box;
hanging a moving plate from an end of the first electrical terminal inside the chamber so that the moving plate rotates freely about the end of the first electrical terminal;
closing the open box with a lid so that the chamber is fully closed;
placing a fixed plate on an external surface of the lid, so that the moving plate and the fixed plate form a parallel plate capacitor, and the moving plate is inside the chamber and the fixed plate is outside the chamber;
attaching a processor and a memory to the lid or the open box;
attaching a communication device to the lid or the open box, the communication device being configured to transmit the tilt angle to an external device in a wireless manner; and
providing a power source to power the processor, the memory and the communication device.
